(19) United States
(12) Patent Application Publication
(10) Pub. No.: US 2018/0139325 A1
(43) Pub. Date: May 17, 2018

(54) COMMUNICATION SYSTEM, COMMUNICATION MANAGEMENT METHOD, AND MEDIUM

(71) Applicants: Akihiro MIHARA, Tokyo (JP); Junichi WADA, Kanagawa (JP)

(72) Inventors: Akihiro MIHARA, Tokyo (JP); Junichi WADA, Kanagawa (JP)

(21) Appl. No.: 15/574,367

(22) PCT Filed: May 20, 2016
(86) PCT No.: PCT/JP2016/002475

§ 371 Date: Nov. 15, 2017

(30) Foreign Application Priority Data
Jul. 23, 2015 (JP) 2015-145711

(51) Int. Cl. H04M 3/51; H04M 3/56

(52) U.S. Cl. CPC H04M 3/5183; H04M 3/567; H04N 7/15; H04M 2201/50; H04M 3/5133

(57) ABSTRACT

At an actual reception counter, for example, a person in charge of reception can see appearance and belongings of a visitor, and may guess the business of the visitor before the visitor reaches the reception counter. However, in communication between communication terminals, there is a problem about usability such that contents on one side cannot be confirmed on a communication terminal on the other side before requesting communication. To solve the problem, when communication has been established between one or more terminals on a customer side and a terminal on an operator side, the output control unit of the terminal on the operator side executes control for starting output of content data of the terminals on the customer side at the terminal itself. Based on a request for starting output by the terminal on the operator side, the output control unit of the terminal on the customer side executes control for starting output of content data of the terminal on the operator side.

### TECHNICAL FIELD

The following disclosure generally relates to a communication system, a communication management method, and medium.

### BACKGROUND ART

In recent years, in accordance with, for example, a demand for reducing travel cost and time, a communication system which provides calling and conferencing over a communication network such as the Internet or a dedicated line or the like has become popular.

In this kind of communication system, when a communication between communication terminals is started, content data such as image data and audio data are sent and received (see PTL 1).

When using a communication system at a call center, a method is known in which, in response to a connection request from a video phone, a call center apparatus selects a currently available operator terminal to receive a call, and establishes a communication channel for video and audio between the selected operator terminal and the video phone (see PTL 2). This makes it possible for an operator terminal that is in a state in which an incoming call can be received after having terminated communication with a video phone, to start communication with another video phone.

### SUMMARY OF INVENTION

### Technical Problem

Incidentally, for example, at an actual reception counter, a person in charge of reception can see appearance and belongings of a visitor, and may guess the business of the visitor before the visitor reaches the reception counter. However, in communication between communication terminals, there is a problem about usability such that contents on one side cannot be confirmed on a communication terminal on the other side before requesting for communication, and the like.

### Solution to Problem

According to an embodiment, a communication system includes an output control unit on another side configured, when communication has been established between one or more communication terminals on one side, and a communication terminal on the other side, to execute control for starting output of content data of the communication terminals on the one side at the communication terminal on the other side; a start request reception unit configured, when the control has been executed for starting the output of the content data of the communication terminals on the one side at the communication terminal on the other side, to receive a request for starting the output of the content data of the communication terminal on the other side at one of the communication terminals on the one side, by the communication terminal on the other side; and an output control unit on the one side configured to execute, based on the request for the starting, the control for starting the output of the content data of the communication terminal on the other side at the one of the communication terminals on the one side.

### Advantageous Effects of Invention

An embodiment implemented by the disclosure has an effect that usability can be improved in communication between communication terminals.

### BRIEF DESCRIPTION OF DRAWINGS

FIG. 1 is a schematic diagram of a communication system according to an embodiment;

FIG. 2 is an external view of a terminal according to an embodiment;

FIG. 3 is a hardware configuration diagram of a terminal according to an embodiment;

FIG. 4 is a hardware configuration diagram of a management system according to an embodiment;

FIG. 5 is a software configuration diagram of a terminal according to an embodiment;

FIG. 6 is a functional block diagram of a terminal and a management system constituting a part of a communication system according to an embodiment;

FIG. 7A is a schematic view of a table managed by a management system;

FIG. 7B is a schematic view of a table managed by a management system;

FIG. 7C is a schematic view of a table managed by a management system;

FIG. 7D is a schematic view of a table managed by a management system;

FIG. 7E is a schematic view of a table managed by a management system;

FIG. 8 is a sequence chart that illustrates a process starting with activating a terminal, and terminating with displaying an application list;

FIG. 9 is a diagram that illustrates a screen example of an application list;

FIG. 10 is a sequence chart that illustrates a process of requesting for participation in a session;

FIG. 11A is a schematic view that illustrates a state of reception/transmission of various information items in a communication system;

FIG. 11B is a schematic view that illustrates a state of reception/transmission of various information items in a communication system;

FIG. 12A is a diagram that illustrates a display example on a display;

FIG. 12B is a diagram that illustrates a display example on a display;

FIG. 13 is a sequence chart that illustrates a process of starting or stopping output of content data;

FIG. 14A is a diagram that illustrates a display example on a display;

FIG. 14B is a diagram that illustrates a display example on a display;

FIG. 14C is a diagram that illustrates a display example on a display;

FIG. 15 is a sequence chart that illustrates a process of requesting for participation in a session; and

FIG. 16 is a sequence chart that illustrates a process of starting or stopping output of content data.

### DESCRIPTION OF EMBODIMENTS

In the following, referring to the drawings, an embodiment of the present invention will be described in detail. It should be noted that in the following, “communication terminal” may be simply described as “terminal”, and “communication management system” may be simply described as “management system”.

<<Overall Configuration of Communication System 1>>

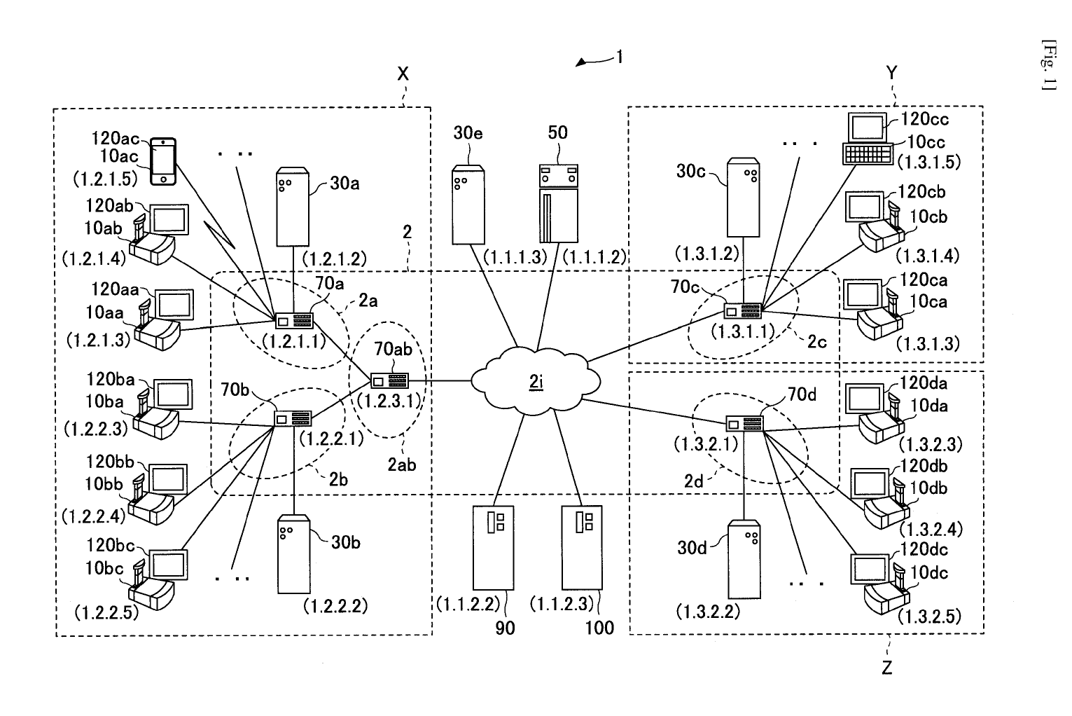

FIG. 1 is a schematic diagram of a communication system 1 according to an embodiment of the present invention. As shown in FIG. 1, the communication system 1 includes a plurality of terminals (10aa, 10ab, . . . ), displays (120aa, 120ab, . . . ) for the terminals (10aa, 10ab, . . . ), a plurality of relay apparatuses (30a, 30b, 30c, 30d, 30e), a management system 50, a program providing system 90, and a maintenance system 100. A video conference or the like between remote places can be realized by having communication of image data or audio data as an example of content data performed by the communication system 1. It should be noted that a plurality of routers (70a, 70b, 70c, 70d, 70ab) select an optimal route of the content data.

The terminals (10aa, 10ab, 10ac, . . . ), the relay apparatus 30a, and the router 70a are connected to each other and are capable of communicating with each other via a LAN 2a. The terminals (10ba, 10bb, 10bc, . . . ), the relay apparatus 30b, and the router 70b are connected to each other and are capable of communicating with each other via a LAN 2b. Further, the LAN 2a and the LAN 2b are connected to each other and are capable of communicating with each other by a dedicated line 2ab including the router 70ab. Further, the LAN 2a, the LAN 2b, and the dedicated line 2ab are provided in a predetermined area X. It should be noted that the devices are not necessarily connected to each other by the dedicated line, but may be directly connected to the Internet 2i.

The terminals (10ca, 10cb, 10cc, . . . ), the relay apparatus 30c, and the router 70c are connected to each other and are capable of communicating with each other via a LAN 2c. The LAN 2c is provided in a predetermined area Y.

The terminals (10da, 10db, 10dc, . . . ), the relay apparatus 30d, and the router 70d are connected to each other and are capable of communicating with each other via a LAN 2d. The LAN 2d is provided in a predetermined area Z. The area X, the area Y, and the area Z may be located in the same country or in different countries.

The area X, the area Y, and the area Z are connected to each other and are capable of communicating with each other via the Internet 2i through respective routers (70ab, 70c, 70d). It should be noted that a call center is located in the area Z. The terminals 10 can receive a reception service by connecting to the terminals (10da, 10db, 10dc, . . . ) in the call center.

It should be noted that in the following, an arbitrary terminal of the terminals (10aa, 10ab, . . . ) is described as a “terminal 10”, an arbitrary display of the displays (120aa, 120ab, . . . ) is described as a “display 120”, and an arbitrary relay apparatus of the relay apparatuses (30a, 30b, 30c, 30d, 30e) is described as a “relay apparatus 30”. Further, an arbitrary router of the routers (70a, 70b, 70c, 70d, 70ab) is described as a “router 70”.

Further, the management system 50, the program providing system 90, and the maintenance system 100 are connected to the Internet 2i. It should be noted that the management system 50, the program providing system 90, and the maintenance system 100 may be located in the areas (X, Y, Z), or may be located in an area other than these areas.

Further, a communication network 2 in the present embodiment includes the LANs (2a, 2b, 2c, 2d), the dedicated line 2ab, the Internet 2i, LAN 2c, and the LAN 2d. In the communication network 2, there may be an area in which not only wired communication is performed, but also wireless communication such as communication via WiFi (Wireless Fidelity), Bluetooth (registered trade mark), a mobile telephone network or the like is performed.

Further, in FIG. 1, a set of four numbers shown under each terminal 10, each relay apparatus 30, the management system 50, each router 70, the program providing system 90, or the maintenance system 100 illustrates a typical IP address of IPv4 in a simplified manner. Further, instead of IPv4, IPv6 may be used. However, for the sake of simplicity, IPv4 is used in the description.

Further, in each terminal 10, when an application, which will be described later, is started, communications between users become available by sending and receiving content data including audio data or image data. Furthermore, the terminal 10 sends and receives call data by using a predetermined communication method (a call control method for connecting or disconnecting with a destination, and a coding method for IP packetizing the call data). It should be noted that in the following, “application” may be abbreviated as “appli” for short.

Further, as the call control method described above, (1) SIP (Session Initiation Protocol), (2) H.323, (3) enhanced SIP protocol, (4) protocol for instant messenger, (5) protocol utilizing a MESSAGE method of SIP, (6) protocol of Internet Relay Chat (IRC), (7) protocol enhanced from a protocol for instant messenger, or the like, can be listed. The above (4) protocol for instant messenger is a protocol used for, for example, (4-1) Extensible Messaging and Presence Protocol (XMPP), (4-2) ICQ (registered trademark), AIM (registered trademark), or Skype (registered trademark). Further, the above (7) Jingle, for example, is a protocol enhanced from the protocol for instant messenger.

<<Hardware Configuration of the Embodiment>>

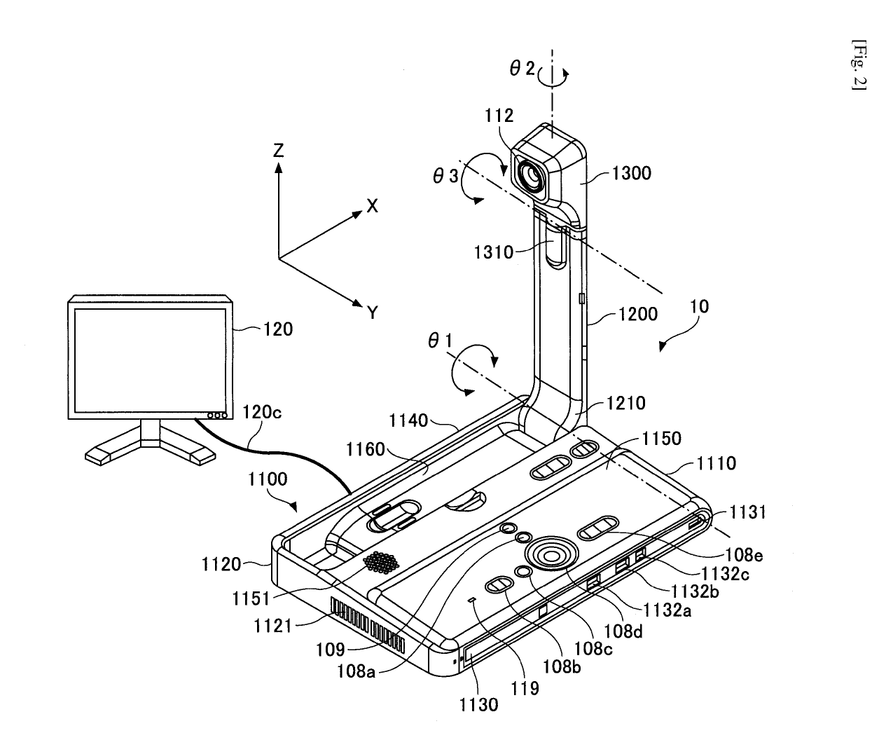

Next, a hardware configuration of the present embodiment will be described. FIG. 2 is an external view of a terminal 10 according to an embodiment. As shown in FIG. 2, the terminal 10 includes a housing 1100, an arm 1200, and a camera housing 1300. In a front wall 1120 of the housing 1100, there is an air intake surface 1121 formed with a plurality of air intake holes, and, in a rear wall 1110 of the housing 1100, there is an air exhaust surface formed with a plurality of air exhaust holes. With the above arrangement, by driving a cooling fan embedded in the housing 1100, it becomes possible to take in air in front of the terminal 10 through the air intake surface 1121, and to exhaust the air to the rear of the terminal 10 through the air exhaust surface. Through a sound pickup hole 1131 formed on a right side wall 1130 of the housing 1100, a built-in mike 114, which will be described later, can pick up sound such as voice, sound, noise, etc.

In the right wall 1130 side of the housing 1100, an operation panel 1150 is formed. In the operation panel 1150, there are a plurality of operation buttons (108a through 108e), a power supply switch 109, and an alarm lamp 119, which will be described later. Further, a sound output surface 1151 is formed in the operation panel 1150, which is formed by a plurality of sound output holes used for passing output sound from a built-in speaker 115, which will be described later. Further, on a part of the housing 1100 close to the left wall 1140, a housing unit 1160 is formed as a concave portion for housing the arm 1200 and the camera housing 1300. On the right wall 1130 of the housing 1100, a plurality of connection ports (1132a through 1132c) are formed for electrically connecting cables for an external device connection I/F 118, which will be described later. On the other hand, on the left wall 1140 of the housing 1100, a connection port is formed for electrically connecting a cable 120c of a display 120 for a display I/F 117.

It should be noted that in the following, an arbitrary operation button of the operation buttons (108a through 108e) will be described as an “operation button 108”, and an arbitrary connection port of the connection ports (1132a through 1132c) will be described as a “connection port 1132”.

Next, the arm 1200 is attached to the housing 1100 via a torque hinge 1210, and is capable of rotating in an up-and-down direction within a range of tilt angle θ1 of 135 degrees with respect to the housing 1100. FIG. 2 illustrates a state in which the tilt angle is 90 degrees. In the camera housing 1300, there is a built-in camera 112, which will be described later, and is capable of taking images of a user, a document, a room, etc. Further, in the camera housing 1300, a torque hinge 1310 is formed. Further, the camera housing 1300 is attached to the arm 1200 via the torque hinge 1310. The camera housing 1300 is capable of rotating in a right-and-left direction within a range of +/−180 degrees of pan angle θ2, and rotating in an up-and-down direction within a range of +/−45 degrees of tilt angle θ3, with respect to the arm 1200, assuming that FIG. 2 illustrates a state in which θ2 and θ3 are zero degrees.

It should be noted that an external view of the terminal 10 is not limited to the view shown in FIG. 2, which is just an example. As another example, the terminal 10 may be a general-purpose computer, a mobile phone terminal, a projector, an electronic white board, digital signage, or the like (refer to the terminals (10ac, 10cc) in FIG. 1). When a computer used for the terminal 10 does not include a mike and a camera, an external mike and an external camera can be connected to the computer. Further, in the case where the terminal 10 is a general-purpose computer, a mobile telephone terminal, or the like, the terminal 10 may be connected to the Internet 2i through wireless communication utilizing a wireless LAN, a mobile telephone network, etc. Further, in the case where a general-purpose computer is used as a terminal 10, an application may be installed beforehand which causes the computer to perform processes of the terminal 10 which will be described later.

It should be noted that external views of the management system 50, the program providing system 90, and the maintenance system 100 are the same as an external view of a typical server computer, and thus, descriptions of the external views will be omitted.

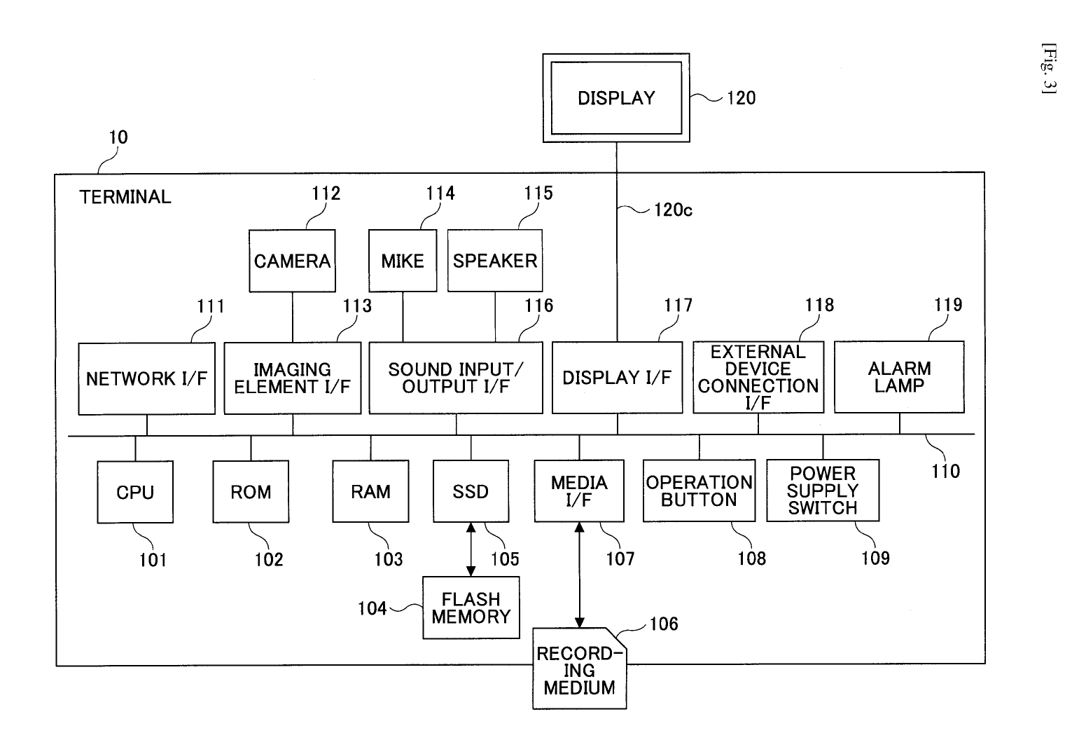

FIG. 3 is a hardware configuration of a terminal 10 according to an embodiment. The terminal 10 includes a central processing unit (CPU) 101 for controlling overall operations of the terminal 10; a read only memory (ROM) 102 in which programs used for driving the CPU 101 such as an initial program loader are stored; a random access memory (RAM) 103 which is used for a work area of the CPU 101; a flash memory 104 in which programs for the terminal 10, and various kinds of data including image data, audio data, etc., are stored; a solid state drive (SSD) 105 which controls writing and reading the various data to and from the flash memory 104 according to the control of the CPU 101; a media I/F 107 which controls writing and reading data to and from a recording medium 106 including a flash memory, an integrated circuit (IC) card, etc.; the operation buttons 108 operated for, for example, selecting a destination of the terminal 10; the power supply switch 109 for switching ON/OFF the power supply of the terminal 10; and a network interface (I/F) 111 for performing data transmission by utilizing the communication network 2.

Further, the terminal 10 includes the built-in camera 112 which captures image data by taking an image of a subject according to the control of the CPU 101; an imaging element I/F 113 which controls driving the camera 112; the built-in mike 114 for inputting sound; a built-in speaker 115 for outputting sound; a sound input/output I/F 116 for processing input/output of an audio signal between the mike 114 and the speaker 115 according to the control of the CPU 101; the display I/F 117 for transmitting image data to the external display 120 according to the control of the CPU 101; the external device connection I/F 118 for connecting various external devices; the alarm lamp 119 for indicating an error of various functions of the terminal 10; and a bus line 110 such as an address bus, a data bus, etc., for electrically connecting the above elements as shown in FIG. 3.

The display 120 is a display unit used for displaying a subject image or the like. Examples of the display 120 include a liquid crystal and an organic electroluminescence (EL) panel. Further, the display 120 is connected to the display I/F 117 via the cable 120c. The cable 120c may be a cable for an analog RGB (VGA) signal, a cable for a component video, or a cable for a signal of High-Definition Multimedia Interface (HDMI) (registered trademark) or Digital Video Interactive (DVI).

The camera 112 includes a lens and a solid-state image sensing device to convert light into electric charge for computerizing the subject image, and as the solid-state image sensing device, a Complementary Metal Oxide Semiconductor (CMOS), a Charge Coupled Device (CCD), etc., are used.

To the external device connection I/F 118, via a Universal Serial Bus (USB) cable or the like, which is inserted into the connection port 1132 of the housing 1100, external devices such as an external camera, an external mike, and an external speaker can be electrically connected. In the case where the external camera is connected, according to the control of the CPU 101, priority is given to the external camera to be driven over the built-in camera 112. Similarly, in the case where an external mike is connected or an external speaker is connected, according to the control of the CPU 101, priority is given to the external mike or the external speaker over the built-in mike 114 or the built-in speaker 115, respectively.

It should be noted that the recording medium 106 can be easily attached or detached with the terminal 10. Further, as a non-volatile memory to/from which data are written/read under control of the CPU 101, an Electrically Erasable and Programmable ROM (EEPROM) may be used, not limited to the flash memory 104.

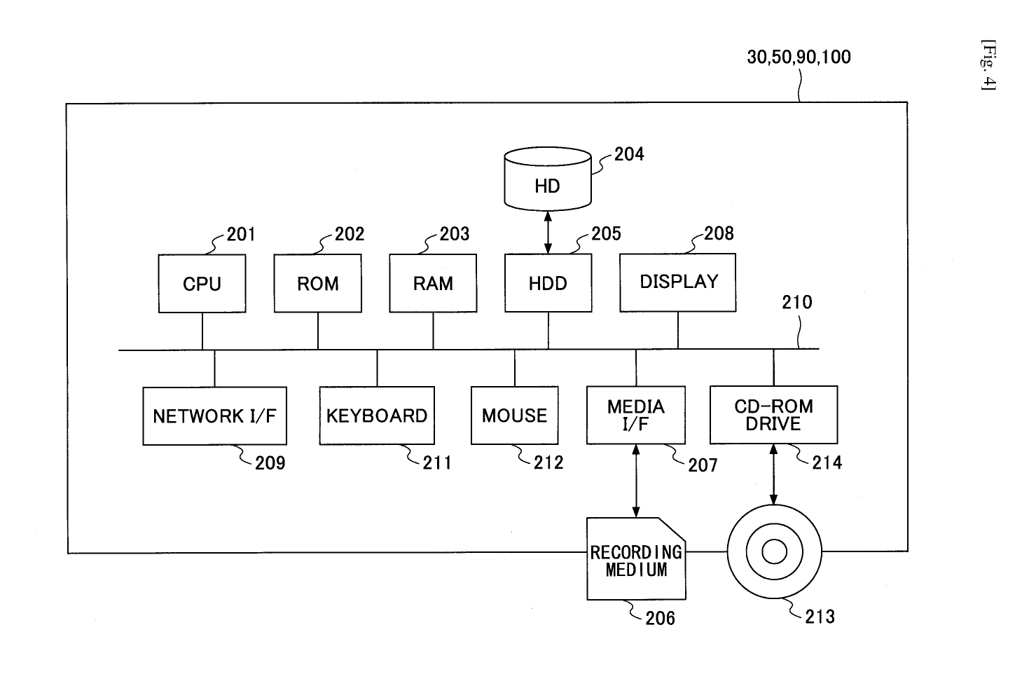

FIG. 4 is a hardware configuration diagram of a management system 50 according to an embodiment. The management system 50 includes a CPU 201 for controlling overall operations of the management system 50; a ROM 202 in which programs used for driving the CPU 201 such as an IPL are stored; a RAM 203 which is used for a work area of the CPU 201; a HD 204 for storing various data including programs for the management system 50, etc.; a hard disk drive (HDD) 205 for controlling various data reading and data writing of the HD 204 according to the control of the CPU 201; a medium I/F 207 for controlling data reading and data writing (storage) of a recording medium 206 including a flash memory; a display 208 for displaying various information items including a cursor, a menu, a window, a character, or an image; a network I/F 209 for performing data communications by using the communication network 2; a keyboard 211 including a plurality of keys for inputting characters, numerical values, various instructions, etc.; a mouse 212 for selecting and executing various instructions, selecting an object to be processed, moving the cursor, or the like; a compact disc read-only memory (CD-ROM) drive 214 for controlling various data reading of a CD-ROM 213 as an example of a detachable recording medium; and a bus line 210 such as an address bus, a data bus, etc., for electrically connecting the above elements as shown in FIG. 4.

On the other hand, the relay apparatus 30, the program providing system 90, and the maintenance system 100 have similar hardware configurations as the above management system 50, and thus, the descriptions will be omitted.

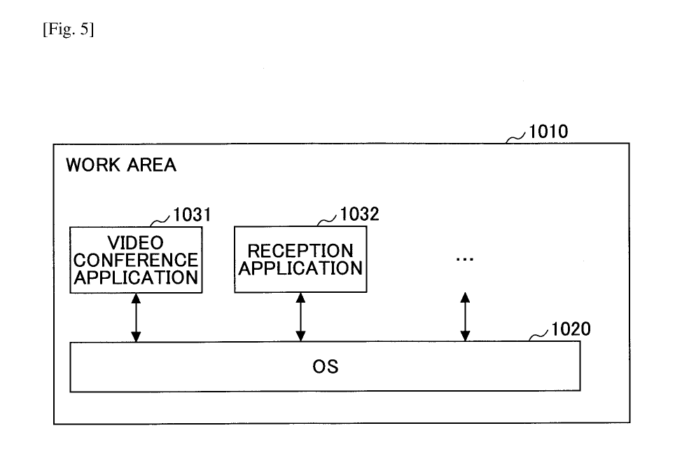

FIG. 5 is a software configuration of the terminal 10 according to an embodiment. As shown in FIG. 5, an OS 1020, a video conference application 1031, and a reception application 1032 are held in a work area 1010 of the RAM 103. The OS 1020 and these applications are installed in the terminal 10.

Further, the OS 1020 provides basic functions, and is basic software which controls the entire terminal 10. The video conference application 1031 is an application for connecting with another terminal 10 and performing a video conference. The reception application 1032 is an application for connecting with a terminal 10 of a call center, and communicating with an operator.

It should be noted that the above applications are just examples, and other applications may be installed. In the case where the other applications are installed, the other applications may be stored in the program providing system 90, and the other applications may be downloaded on demand from the terminal 10. Further, in the case where multiple video conference applications are installed, video conference applications using different protocols such as the above (1) through (7) may be installed.

<<Functional Configuration of Embodiment>>

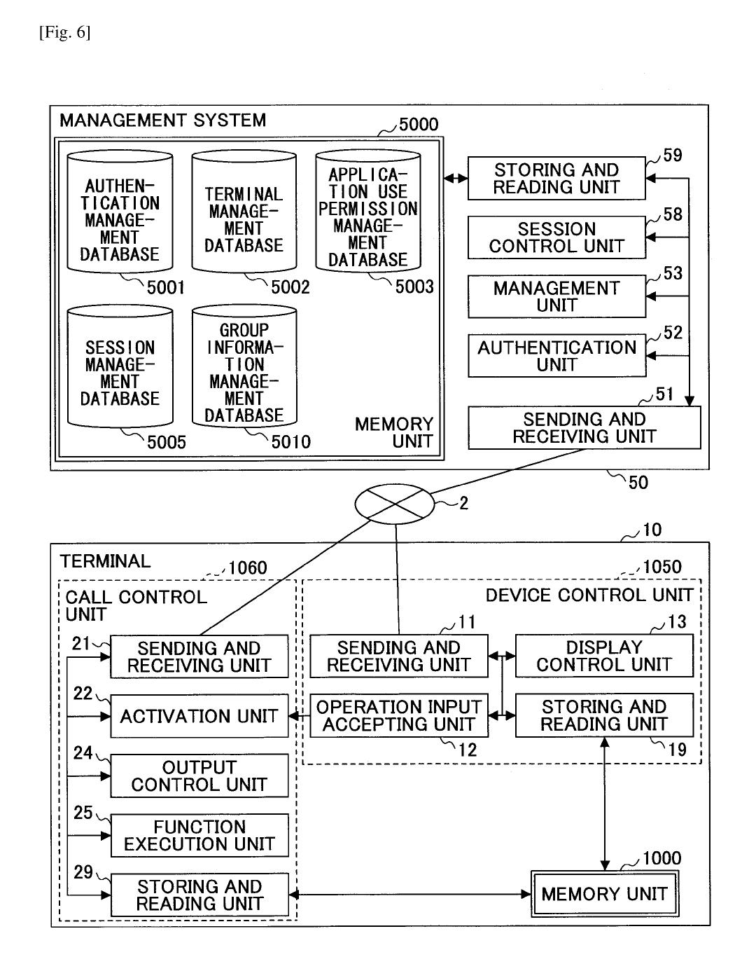

Next, a functional configuration of the present embodiment will be described. FIG. 6 is a functional block diagram of a terminal 10 and the management system 50 included as a part of the communication system 1 according to the embodiment. It should be noted that in FIG. 6, the terminal 10 and the management 50 are connected to perform data communications via the communication network 2.

<Functional Configuration of Communication Terminal>

The terminal 10 includes a device control unit 1050 and a call control unit 1060. Among these, the device control unit 1050 is implemented by running the OS 1020. Further, the call control unit 1060 is implemented by activating the video-conference application 1031 or the reception application 1032.

Further, the device control unit 1050 includes a sending and receiving unit 11, an operation input receiving unit 12, a display control unit 13, and a storing and reading unit 19. These units are functions realized by elements shown in FIG. 3 that operate by instructions from the CPU 101 which executes an activated application (program) read from the flash memory 104 and loaded on the RAM 103.

On the other hand, the call control unit 1060 includes a sending and receiving unit 21, an activation unit 22, an output control unit 24, a function execution unit 25, and a storing and reading unit 29. These units are functions realized by elements shown in FIG. 3 that operate by instructions from the CPU 101 which executes the video-conference application 1031 or the reception application 1032 (program) read from the flash memory 104 and loaded on the RAM 103.

Further, the terminal 10 includes a memory unit 1000 including the ROM 102, the RAM 103, and the flash memory 104 shown in FIG. 3.

(Functional Configuration of Device Control Unit)

Next, a functional configuration of the device control unit 1050 in the terminal 10 will be described in detail. It should be noted that in the following, when the functional configuration of the device control unit 1050 in the terminal 10 is described, relations between functions and main elements among the elements shown in FIG. 3, which are used for realizing the functions of the device control unit 1050, will also be described.

The sending and receiving unit 11 is realized by instructions from the CPU 101 and the network I/F 111, and performs sending and receiving various data (or information) to and from a terminal, an apparatus, a system, etc., as communication counterparts, via the communication network 2.

The operation input accepting unit 12 is realized by instructions from the CPU 101, the operation buttons (108a, 108b, 108c, 108d, 108e) and the power supply switch 109, and accepts various inputs or various selections made by a user.

The display control unit 13 is realized by instructions from the CPU 101 and the display I/F 117, and controls displaying an image on the display 120.

The storing and reading unit 19 is realized by instructions from the CPU 101 and the SSD 105, or by instructions from the CPU 101, and performs a process of storing various data in the memory unit 1000 and reading the various data stored in the memory unit 1000.

(Functional Configuration of Call Control Unit)

Next, a functional configuration of the call control unit 1060 in the terminal 10 will be described in detail. It should be noted that in the following, when the functional configuration of the call control unit 1060 in the terminal 10 is described, relations between functions and main elements among the elements shown in FIG. 3, which are used for realizing the functions of the call control unit 1060 in the terminal 10, will also be described.

The sending and receiving unit 21 is realized by instructions from the CPU 101 and the network I/F 111, and performs sending and receiving various data (or information) to and from a terminal, an apparatus, a system, etc., as communication counterparts, via the communication network 2.

The activation unit 22 is realized by instructions from the CPU 101, and starts up operations of the call control unit 1060 (the video-conference application or the reception application), based on a request for activation from the operation input accepting unit 12 of the device control unit 1050 when the operation input accepting unit 12 receives a selection of an application by the user.

The output control unit 24 is realized by instructions from the CPU 101 and the display I/F 117, and controls outputting screen data on the display 120. The output control unit 24 is also realized by instructions from the CPU 101 and the sound input/output I/F 116, controls outputting sound from the speaker 115, and inputting sound from the mike 114.

The function execution unit 25 is realized by instructions from the CPU 101, the camera 112, the mike 114 or the speaker 115, etc., and executes control for realizing a call by image or sound.

The storing and reading unit 29 is realized by instructions from the CPU 101 and the SSD 105 or by instructions from the CPU 101, and performs a process of storing various data in the memory unit 1000 and reading the various data stored in the memory unit 1000.

<Functional Configuration of Management System>

The management system 50 includes a sending and receiving unit 51, an authentication unit 52, a management unit 53, a session control unit 58, and a storing and reading unit 59. These units are functions realized by elements shown in FIG. 4 that operate by instructions from the CPU 201 which executes a program for the management system 50 read from the flash memory 204 and loaded on the RAM 203. Further, the management system 50 includes a memory unit 5000 including the HD 204. This memory unit 5000 stores data of application icons for respective application IDs. Furthermore, in the memory unit 5000, databases (DBs) including corresponding tables as described below are included.

(Authentication Management Table)

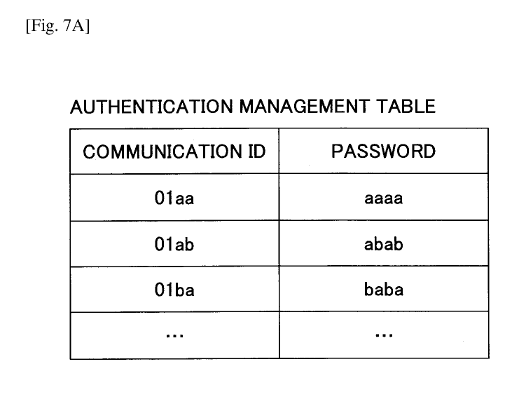

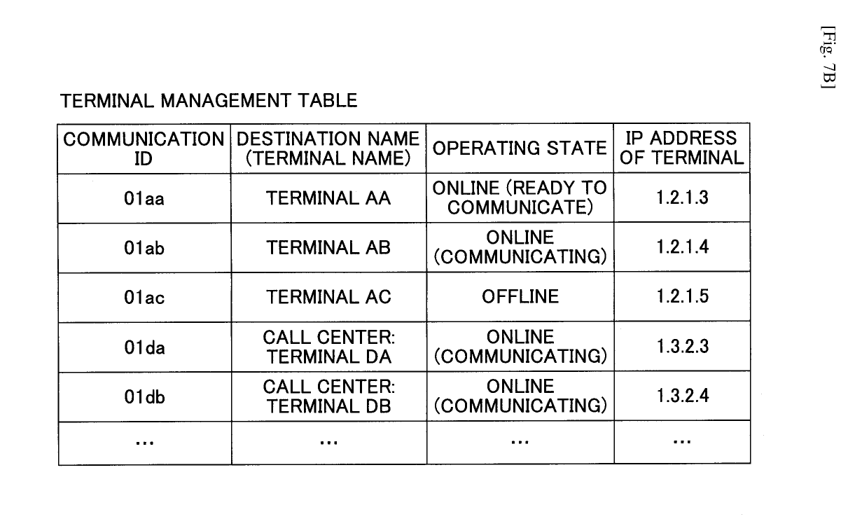

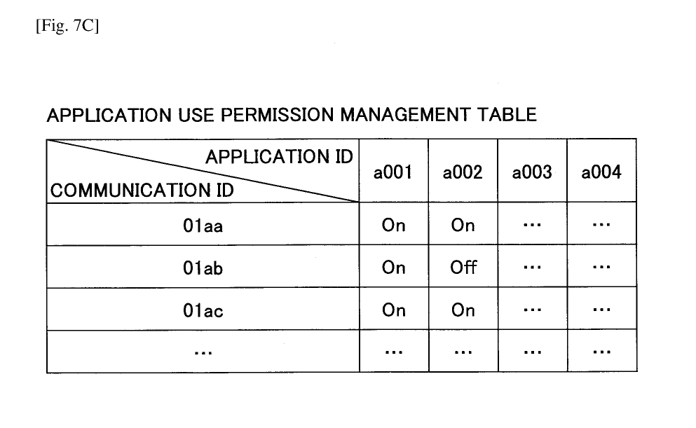

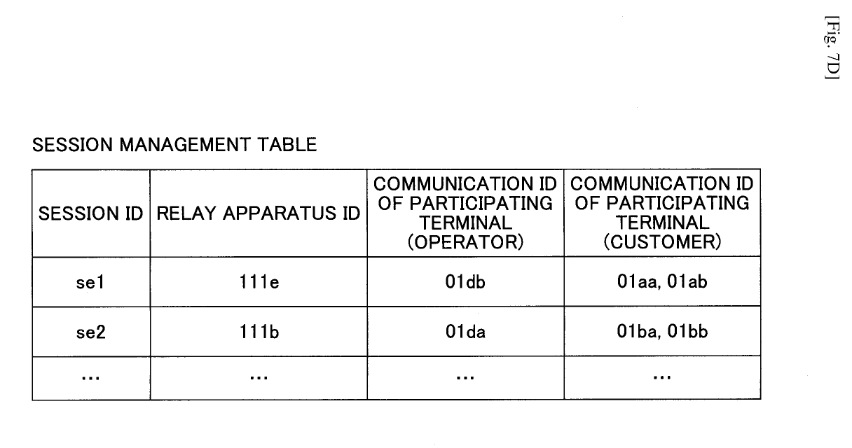

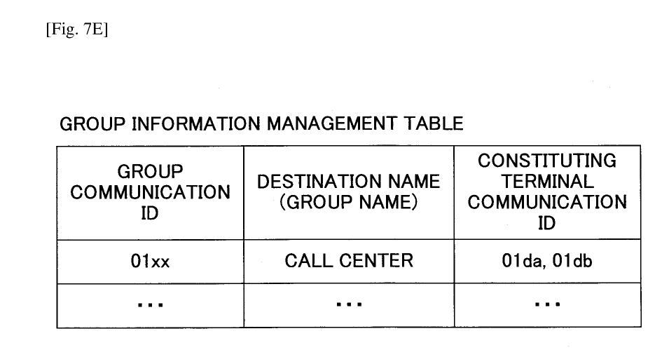

FIG. 7A is a schematic view illustrating an authentication management table. In the memory unit 5000, an authentication management DB 5001 including the authentication management table as shown in FIG. 7A is included. In the authentication management table, for each communication ID of every terminal 10 managed by the management system 50, the communication ID is associated with a password for authentication and stored to be managed. It should be noted that the communication ID is information for identifying a destination of communication in the communication system 1. The communication ID is not limited specifically, and may be identification information of the terminal 10, account information of a user of the terminal 10, identification information of a group constituted with multiple terminals 10, or the like. In the following, a case will be described where the communication ID is the identification information of the terminal 10, or the identification information of a group. In the following, the descriptions will be continued assuming that communication IDs of the terminals (10aa, 10ab, 10ac, 10db) are “01aa, 01ab, 01ac, 01db”, respectively.

(Terminal Management Table)

FIG. 7B is a schematic view illustrating a terminal management table. In the memory unit 5000, a terminal management DB 5002 including the terminal management table as shown in FIG. 7B is included. In the terminal management table, for each communication ID of every terminal 10, a destination name (terminal name) when the terminal 10 is a destination, an operating state of the terminal 10, and an IP address of the terminal 10 are associated with the communication ID, to be managed. It should be noted that an operation state “OFFLINE” indicates a state in which the terminal 10 is not connected to the management system 50. An operation state “ONLINE (READY TO COMMUNICATE)” indicates a state in which the terminal 10 is connected to the management system 50, but not communicating with another terminal 10. An operation state “ONLINE (COMMUNICATING)” indicates a state in which the terminal 10 is connected to the management system 50, and communicating with another terminal 10, but does not bidirectionally transmit content data with the other terminal 10 being the communication partner. An operation state “ONLINE (TALKING)” indicates a state in which the terminal 10 is connected to the management system 50, communicating with another terminal 10, and bidirectionally transmitting content data with the other terminal 10.

(Application Use Permission Management Table)

FIG. 7C is a schematic view illustrating an application use permission management table. In the memory unit 5000, an application use permission management DB 5003 including the application use permission management table as shown in FIG. 7C is included. In this application use permission management table, for each communication ID of a terminal 10, and for each application ID which identifies one of multiple applications installed in the terminal 10, use permission information is associated to represent whether the application is usable (On) or not usable (Off) on the terminal 10, and to be managed.

(Session Management Table)

FIG. 7D is a schematic view illustrating a session management table. In the memory unit 5000, a session management DB 5005 including the session management table as shown in FIG. 7D is included. In this session management table, for each session ID that identifies a session in which content data is transmitted between terminals 10, the relay device ID of a relay apparatus 30 that relays content data between the terminals 10 in the session, a communication ID of a participating terminal on the call center (operator) side among terminals 10 participating in this session (participating terminals), and a communication ID of a participating terminal 10 on the customer side being the communication partner of the participating terminal on the operator side in this session, are associated to be managed.

(Group Information Management Table)

FIG. 7E is a schematic view illustrating a group information management table. In the memory unit 5000, a group information management DB 5010 including the group information management table as shown in FIG. 7E is included. In this group information management table, a communication ID that identifies a group, a destination name (group name) that specifies the group as the destination of communication, and communication IDs of terminals 10 that constitute the group, are associated to be managed.

<Functional Configuration of Management System>

Next, a functional configuration of the management system 50 will be described in detail. It should be noted that in the following, when the functional configuration of the management system 50 is described, relations between functions and main elements among the elements shown in FIG. 4, which are used for realizing the functions of the management system 50, will also be described.

The sending and receiving unit 51 is realized by instructions from the CPU 201 and the network I/F 209, and performs sending and receiving various data (or information) to and from a terminal, an apparatus, or a system via the communication network 2.

The authentication unit 52 is realized by instructions from the CPU 201, searches in the authentication management table by using the communication ID and password received by the sending and receiving unit 51 as a search key, and determines whether the same communication ID and password are managed in the authentication management table, to authenticate the terminal.

The management unit 53 is realized by instructions from the CPU 201, and performs a process of updating an operation state in the terminal management table (see FIG. 7B) in order to reflect the latest operation state.

The session control unit 58 controls a session for sending and receiving content data between the terminals 10, by instructions from the CPU 201. The control includes establishing a session, controlling the terminal 10 to participate in an established session, terminating a session, and controlling transmission of content data in an established session, and the like.

The storing and reading unit 59 is executed by instructions from the CPU 201 and the HDD 205, or realized by instructions from the CPU 201, stores various data in the memory unit 5000, and extracts various data stored in the memory unit 5000.

<<Processes and Operations of Communication System 1>>

Next, processes and operations of the communication system 1 will be described.

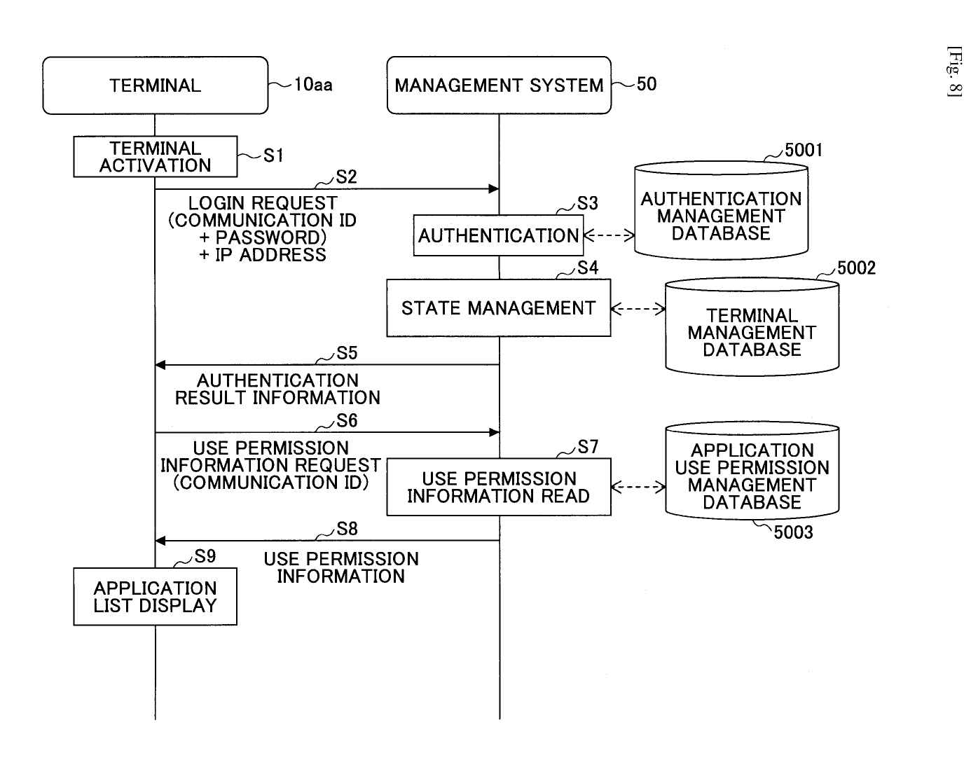

First, using FIG. 8, a process will be described that starts with activating the terminal 10aa, and terminates with displaying an application list. FIG. 8 is a sequence chart that illustrates the process starting with activating the terminal 10aa, and terminating with displaying an application list.

First, when the user turns on the power source switch 109, the operation input accepting unit 12 receives the power-on operation, and activates the terminal 10aa (Step S1). In response to receiving the power-on, the sending and receiving unit 11 transmits a login request to the management system 50 via the communication network 2 (Step S2). This makes the sending and receiving unit 51 of the management system 50 receive the login request. This login request includes the communication ID and password to identify the request source, which is the transmission terminal 10aa. The communication ID and password are data items that have been read from the memory unit 1000 via the storing and reading unit 19, and transmitted to the sending and receiving unit 11. It should be noted that the communication ID and password may be input by the user of the requesting terminal. By having the login request transmitted from the terminal 10aa to the management system 50, the management system 50 on the receiving side can obtain the IP address of the terminal 10aa on the sending side.

Next, the authentication unit 52 of the management system 50 searches in the authentication management table (see FIG. 7A) in the memory unit 5000, by using the communication ID and password included in the login request as a search key, and determines whether the same communication ID and password are managed in the authentication management table, for authentication (Step S3). If the login request is authenticated by the authentication unit 52 as a request that comes from a terminal 10 having a valid use permission, the session management unit 53 has the communication ID “01aa” of the terminal 10aa associate with the operation state “ONLINE (READY TO COMMUNICATE)” and the IP address of the terminal 10aa, and stores it in the terminal management table (see FIG. 7B) (Step S4).

Then, the sending and receiving unit 51 of the management system 50 transmits authentication result information that represents an authentication result obtained by the authentication unit 52, to the terminal 10aa being the source of the login request via the communication network 2 (Step S5). This makes the sending and receiving unit 11 of the terminal 10aa receive the authentication result information.

Once the terminal 10aa has been determined by the authentication unit 52 as a terminal having valid use permission, the sending and receiving unit 11 of the terminal 10aa sends a request for use permission information that represents use permission of applications installed in the terminal 10aa, to the management system 50 via the communication network 2 (Step S6). This request includes the communication ID of the terminal 10aa being the source of the request for the use permission information. This makes the sending and receiving unit 51 of the management system 50 receive the request for the use permission information.

Next, the storing and reading unit 59 of the management system 50 searches in the application use permission management table (see FIG. 7C), by using the communication ID of the terminal 10aa being the source of the request for the use permission information as a search key, to read corresponding use permission information (Step S7). The use permission information in this case designates that the application ID “a001” is set with “On”, and the application ID “a002” is set with “On”.

Next, the sending and receiving unit 51 of the management system 50 transmits the use permission information read out at Step S7 to the terminal 10aa being the source of the request for the use permission information via the communication network 2 (Step S8). This makes the sending and receiving unit 11 of the terminal 10aa receive the use permission information.

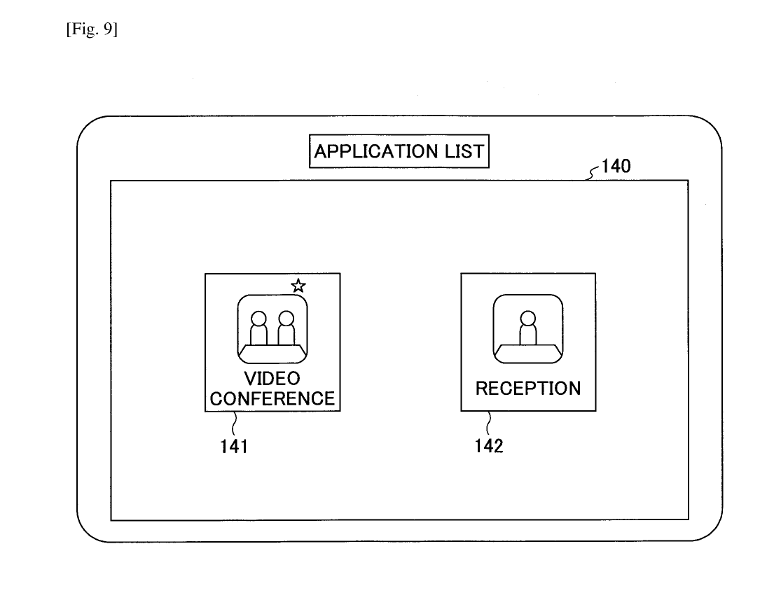

Next, the display control unit 13 of the terminal 10aa displays a screen 140 of an application list as shown in FIG. 9 on the display 120aa (Step S9). Here, FIG. 9 is a diagram that illustrates a screen example of an application list. This screen 140 shows application icons (141, 142, . . . ) that correspond to all of the respective application IDs (a001, a002, . . . ) having the use permission information as usable (On).

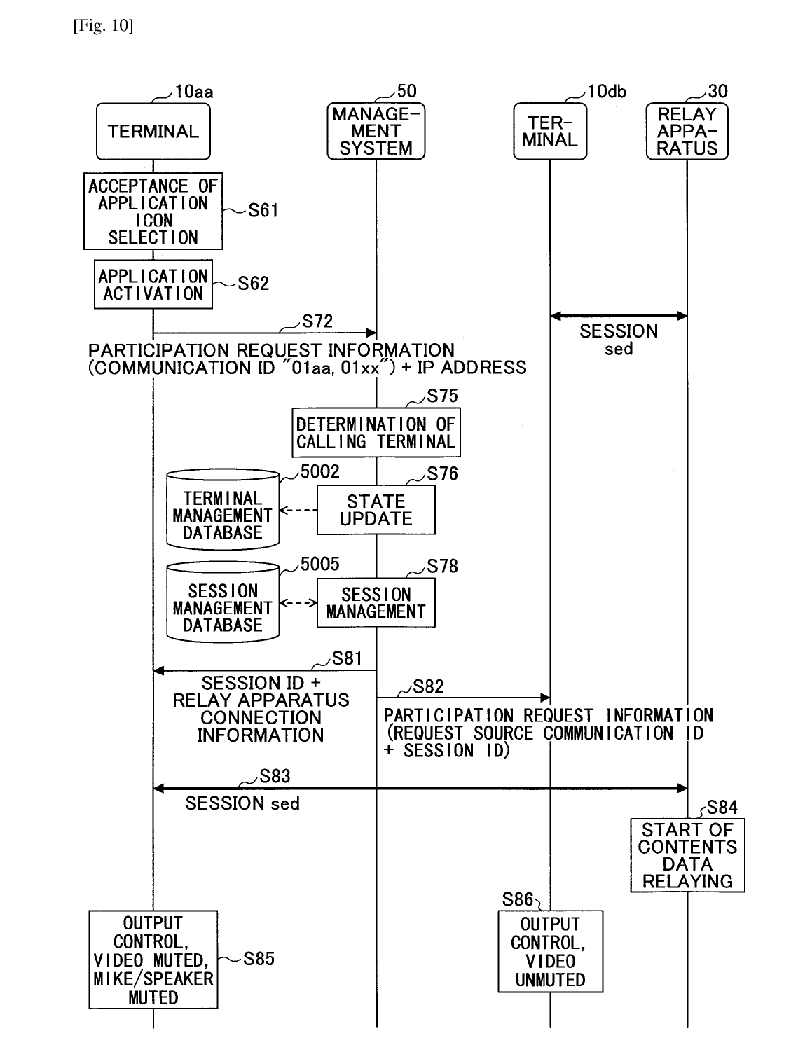

Next, a case will be described in which the application icon 142 is selected by a user of the terminal 10aa, using FIG. 10. FIG. 10 is a sequence chart that illustrates a process of requesting for participation in a session.

After the user of the terminal 10aa has operated the operational buttons (108a to 108e), and selected the application icon 142 that represents the reception application 1032 among the multiple application icons shown in FIG. 9, the operation input accepting unit 12 of the terminal 10aa receives the selection of the application icon by the user (Step S61).

Next, the operation input accepting unit 12 of the device control unit 1050 issues a command to the activation unit 22 implemented by the reception application 1032, to activate the call control unit 1060 that corresponds to the reception application 1032 (Step S62). It should be noted that before this activation, a process has been executed by the device control unit 1050. Once the reception application 1032 has been activated, the process by the call control unit 1060 is now executed.

Next, the sending and receiving unit 21 of the terminal 10aa transmits information about a request for participation in the session, which includes the communication ID “01aa” of the terminal 10aa being the source of the request for participation and the communication ID “01xx” of the destination, to the management system 50, along with the IP address of the terminal 10 being the source of the request for participation (Step S72). It should be noted that the communication ID “01xx” of the destination is a communication ID that represents the call center as the destination, which has been specified automatically by a process of the sending and receiving unit 21 based on the reception application 1032. Further, the information about a request for participation represents a request for participation in a session in which a terminal 10 included in the call center has been participating.

Next, the session control unit 58 of the management system 50 determines a terminal 10 (calling terminal) among the terminals 10 that constitute the group identified with the communication ID “01xx”, to call as the partner to communicate with the terminal 10aa (Step S75). A method of determining the calling terminal is not limited specifically. For example, a method may be considered in which the session control unit 58 refers to the session management table (see FIG. 7D), and selects a participating terminal on the operator side that has the least number of participating terminals on the customer side. In the following, a case will be described in which the terminal 10db is determined as the calling terminal. Further, in the following description, it is assumed that the terminal 10db being the calling terminal has participated in a session sed to transmit content data with other terminals 10 via the relay apparatus 30 at the timing when the calling terminal is determined.

Next, the management unit 53 changes the operation state associated with the communication ID of the terminal 10aa being the source of the start request into “ONLINE (COMMUNICATING)” in the terminal management table (Step S76).

Next, the session control unit 58 adds the communication ID “01aa” of the terminal 10aa being the source of the request for participation in the field for corresponding participating terminals (the customer) in a record that has the communication ID “01db” of the calling terminal (terminal 10db) as the communication ID of the participating terminal (the operator) in the session management table (see FIG. 7D) (Step S78). Further, as a part of Step S78, the session control unit 58 searches in the session management table by using the communication ID “01db” of the calling terminal (terminal 10db) as a search key, to read out the corresponding session ID and the relay device ID.

Next, the sending and receiving unit 51 transmits information about relay device connection for connecting to the relay apparatus 30 identified by the relay device ID read out at Step S78, to the terminal 10aa being the source of the request for participation (Step S81). This information about relay device connection may include the IP address, authentication information, and a port number of the relay apparatus 30, and the session ID read out at Step S78.

Next, the sending and receiving unit 51 transmits the information about the request for participation that includes the session ID read out at Step S78, to the calling terminal 10db (Step S82). In response to the request for participation, the calling terminal 10db may automatically transmit a response to the management system 50 that represents permission for participation. This makes it possible to shorten the time to receive input of permission for participation on the operator side.

The terminal 10aa being the source of the request for participation connects to the relay apparatus 30, by using the information about relay device connection transmitted from the management system 50. Thus, the terminal 10aa participates in the session sed in which the calling terminal 10db has been participating (Step S83). By having the terminals (10aa, 10db) participate in the common session sed, communication is established between the terminals (10aa, 10db). The terminals (10aa, 10db) participating in this session transmit content data (image data and sound data) generated in the respective terminals to the relay apparatus 30.

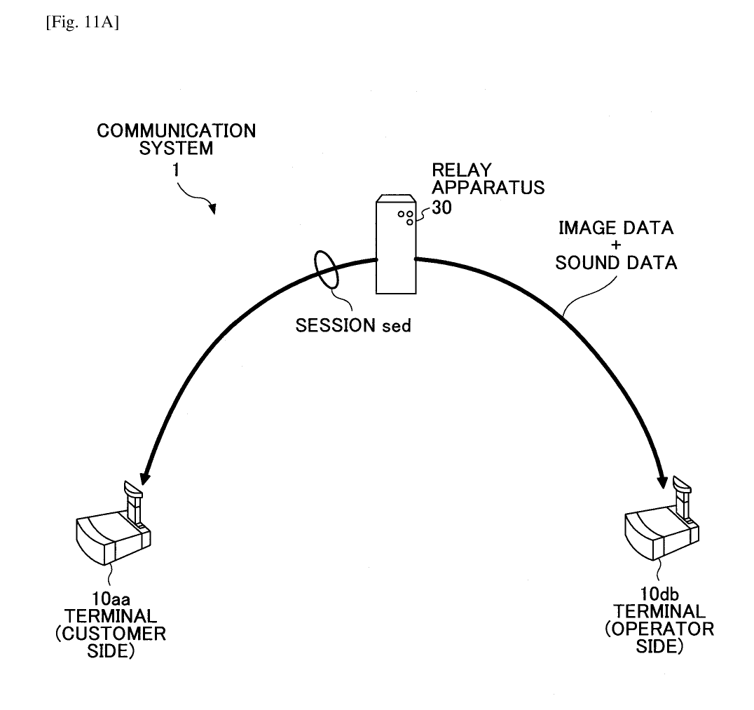

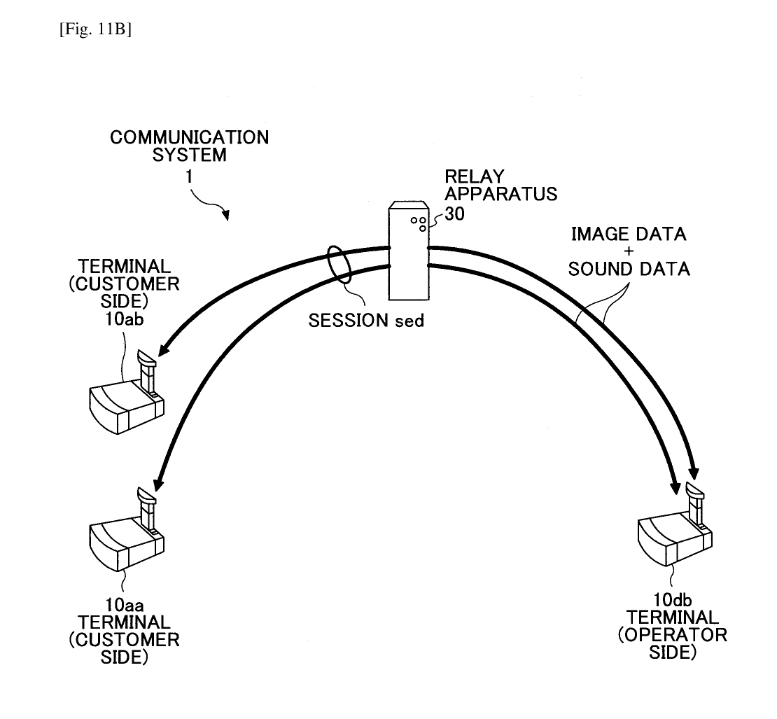

Once the communication has been established between the terminals (10aa, 10db), the relay apparatus 30 starts relaying content data between the terminals (10aa, 10db) (Step S84). FIG. 11A is a schematic view that illustrates a state of reception/transmission of various information items in the communication system. As shown in FIG. 11A, the relay apparatus 30 receives image data and sound data transmitted from the terminal 10aa, and starts transmitting them to the terminal 10db. Further, the relay apparatus 30 receives image data and sound data transmitted from the terminal 10db, and starts transmitting them to the terminal 10aa.

After the communication has been established between the terminals (10aa, 10db), the output control units 24 of the terminals (10aa, 10db) control the sound based on sound data of the terminal 10 on the partner side transmitted via the relay apparatus 30 so as not to be output (Steps S85 and S86). Further, after the communication has been established between the terminals (10aa, 10db), the output control unit 24 of the terminal 10aa on the customer side controls the video based on image data on the operator side transmitted via the relay apparatus 30 so as not to be output. On the other hand, after the communication has been established between the terminals (10aa, 10db), the output control unit 24 of the terminal 10db on the operator side controls the video based on image data on the customer side transmitted via the relay apparatus 30 so that outputting the video starts (Steps S85 and S86).

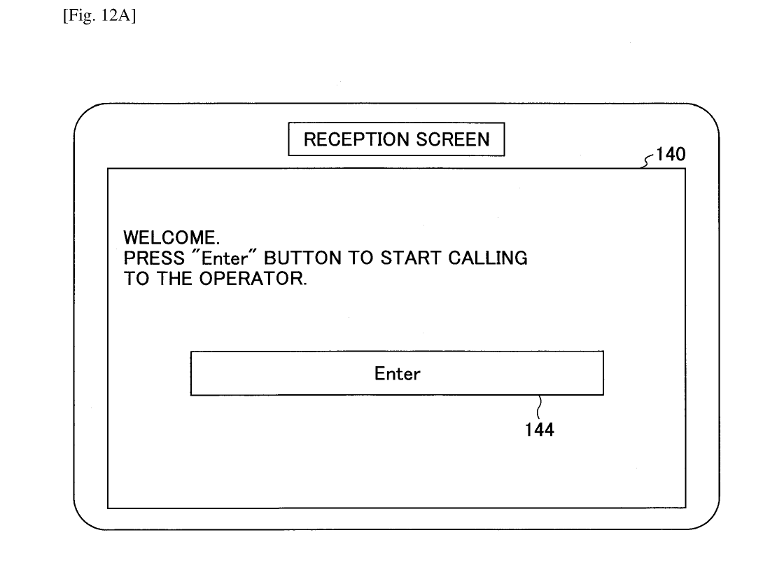

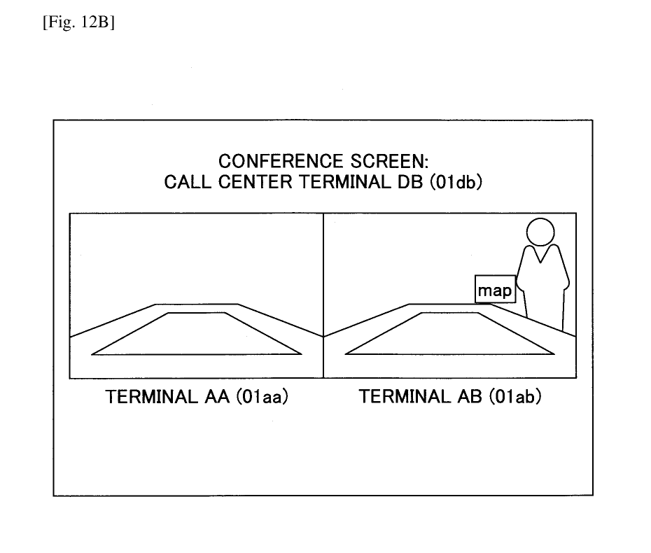

An example of the output control method will be described specifically. The output control unit 24 of the terminal 10aa mutes the video output. Thus, image data of the terminal 10db on the operator side transmitted via the relay apparatus 30 is controlled so as not to be output on the display 120aa on the customer side. The output control unit 24 of the terminal 10aa may output a reception screen for receiving a request for starting a call with the operator side on the display 120aa. FIG. 12A is a diagram that illustrates an example of a reception screen. This screen 140 shows a button 144 to receive a request for starting a call with the operator.

Further, the output control unit 24 of the terminal 10aa puts the mike 114 and the speaker 115 of the terminal itself into a muted state. Thus, sound data on the operator side transmitted via the relay apparatus 30 is controlled so as not to be output to the speaker 115 on the customer side. Further, by muting the mike 114, sound data of no sound is transmitted to the terminal 10db on the operator side. Thus, sound around the terminal 10aa on the customer side is not output at the terminal 10db on the operator side.

On the other hand, the output control unit 24 of the terminal 10db puts the video output into an unmuted state when communication is established. This starts outputting image data of the terminal 10aa on the customer side transmitted via the relay apparatus 30 on the display 120db.

It should be noted that in the present embodiment, the reception application 1032 has been activated on the terminal 10aa on the customer side, and an application corresponding to the reception application 1032 on the operator side has been activated on the terminal 10db on the operator side. Therefore, the terminals (10aa, 10db) can start outputting contents at different timings, following the processes of the respective applications.

If the other terminal 10ab on the customer side makes a request for participation, substantially the same process as Steps S75 to S86 is executed except that the terminal 10aa is replaced with the terminal 10ab. Thus, three terminals can participate in the common session sed. FIG. 11B is a schematic view that illustrates a state of reception/transmission of various information items in the communication system 1, in which the multiple terminals (10aa, 10ab, 10db) have participated in the common session sed. In FIG. 11B, by having the terminals (10aa, 10ab, 10db) participate in the common session sed, communication is established between the multiple terminals (10aa, 10ab) on the customer side and the terminal 10db on the operator side.

Once the communication has been established, on the terminals (10aa, 10ab) on the customer side, reception screens of FIG. 12A are output by processing Step S85, respectively. On the other hand, on the terminal 10db on the operator side, a video-conference screen of FIG. 12B is output by processing Step S86. FIG. 12B is a diagram that illustrates an example of a video-conference screen. In other words, the output control unit 24 of the terminal 10db controls starting output of image data of the terminals (10aa, 10ab) on the customer side transmitted via the relay apparatus 30, on the display 120db. As shown in FIG. 12B, if a new customer appears in the capturing ranges of the cameras 112 of the terminals (10aa, 10ab), the operator of the terminal 10db can confirm appearance of the customer before the new customer makes a request for a call. Here, for example, if a customer having a map appears on the screen of the terminal 10ab, the operator may expect that the customer will ask how to get to a destination location in the next call. Also, if a customer having a pamphlet of a language appears on the screen of the terminal 10ab, the operator may expect that the customer will ask a question in the language in the next call. Thus, the operator can prepare for the next call depending on a circumstance that can be grasped from a screen on the customer side.

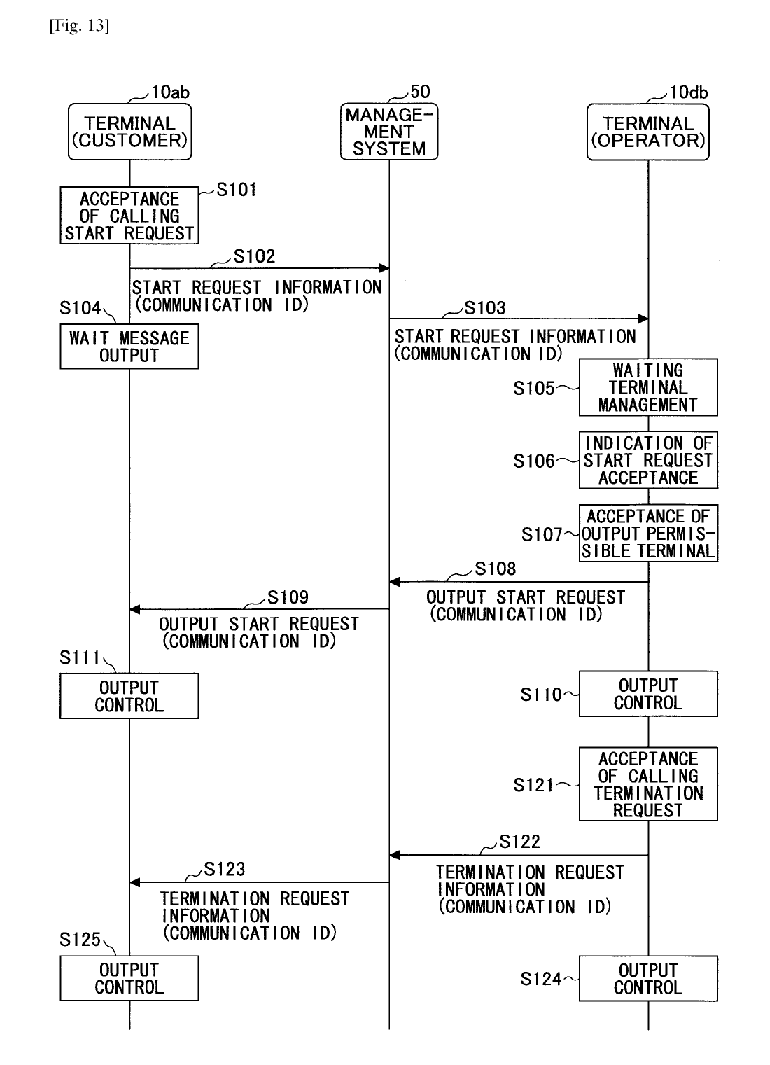

Next, using FIG. 13, a process will be described in which the terminal 10ab on the customer side receives a request for starting a call with the operator side. FIG. 13 is a sequence chart that illustrates a process of starting or stopping output of content data. If a customer presses the button 144 on the reception screen of FIG. 12A at the terminal 10ab, the function execution unit 25 receives a request for starting a call (Step S101). Next, the sending and receiving unit 21 of the terminal 10ab transmits information about the request for starting a call that includes the communication ID “01ab” of the terminal 10ab being the source of the request for starting a call, and the communication ID of the terminal 10db on the partner side, to the management system 50 (Step S102). It should be noted that a request for starting a call may be regarded as a request from the terminal 10ab on the customer side to the terminal 10db on the operator side, for permission for outputting content data on the operator side.

In response to receiving the information about the start request transmitted from the terminal 10ab on the customer side, the sending and receiving unit 51 of the management system 50 transmits the received information about the start request to the terminal 10db on the operator side (Step S103).

After having transmitted the information about the start request, the terminal 10ab on the customer side has the output control unit 24 switch the output image on the display 120ab from the reception screen for the start request to a message asking for waiting until the call becomes ready to start (Step S104). This can avoid receiving a duplicated request for starting a call.

In response to receiving the information about the start request by the sending and receiving unit 21, the terminal 10db on the operator side has the function execution unit 25 manage the terminal 10 being the source of the request for starting the call (Steps S105). In this case, the function execution unit 25 associates the reception time of the start request with the communication ID of the terminal 10ab being the source of the start request, and stores it in the memory unit 1000 via the storing and reading unit 29.

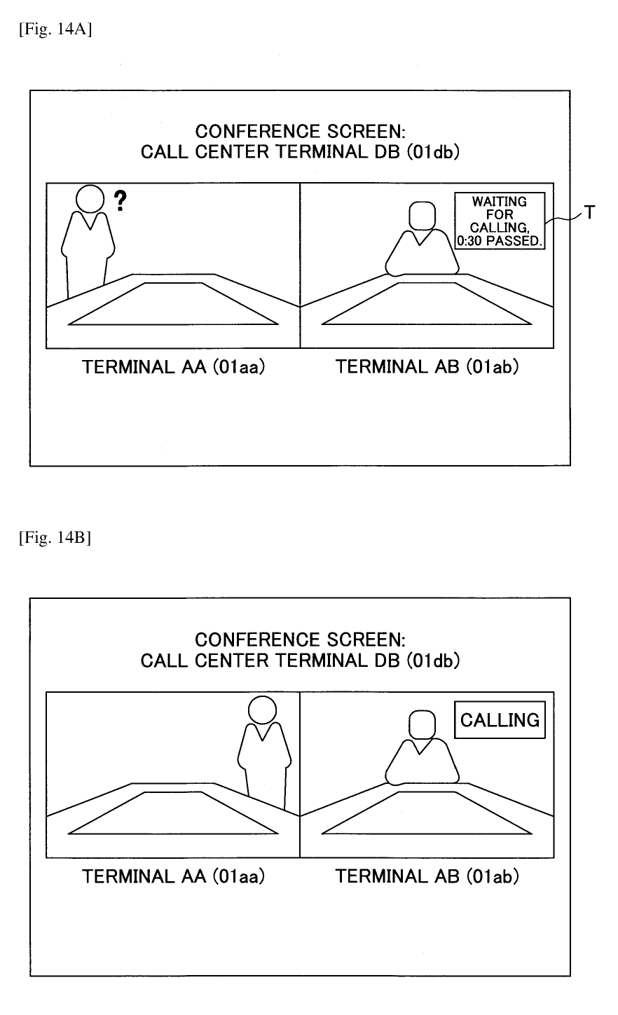

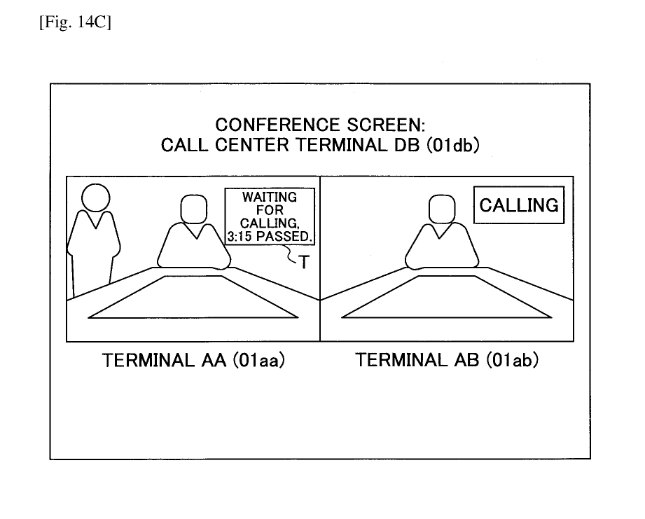

Next, the output control unit 24 of the terminal 10db associates image data of the terminal 10ab being the source of the start request, with a message for indicating that the start request of the terminal 10ab has been received, and outputs it on the display 120db (Step S106). FIG. 14A is a diagram that illustrates an example of a video-conference screen. As shown in FIG. 14A, the output control unit 24 of the terminal 10db may output the elapsed time since the reception time of the start request managed in the memory unit 1000, by associating the elapsed time with corresponding image data on the terminal 10ab side being the source of the start request.

In response to operational input by the user, the operation input accepting unit 12 of the terminal 10db receives a designation of a terminal 10 among the terminals (10aa, 10ab) on the customer side that transmit content data to the terminal 10db, on which output of content data of the terminal 10db is to be permitted (Step S107). In this case, the designation is not limited to the terminal 10ab that has transmitted the start request, but the operation input accepting unit 12 may receive a designation of the terminal 10aa that has not transmitted the start request. For example, if a video on the terminal 10aa side is being output, in which a customer does not seem to understand the operational method of making a request for starting a call (see FIG. 14A), the terminal 10aa may be designated on the operator side so that the operator can start a call with the customer of the terminal 10aa side.

In the following, description will continue for a case in which the terminal 10ab is designated as a terminal 10 on which output of content data of the terminal is to be permitted. Once the designation of a terminal 10 on which output of content data of the terminal is to be permitted has been received, the sending and receiving unit 21 of the terminal 10db transmits a request for starting output that represents a request for starting output the content data of the terminal itself, to the management system 50 (Step S108). The request for starting output includes the communication ID of the terminal 10db that has permitted the start, and the communication ID of the permitted terminal 10ab.

In response to receiving the request for starting output of the terminal 10db on the operator side, the sending and receiving unit 51 of the management system 50 transmits the received start request to the terminal 10ab on which output is permitted (Step S109). This makes the sending and receiving unit 21 of the terminal 10ab receive the request for starting output.

Once the request for starting output has been transmitted/received between the terminals (10ab, 10db), the output control units 24 of the terminals (10ab, 10db) control outputting sound data and image data of the terminal 10 on the partner side (Steps S110 and S111).

An example of the output control method will be described specifically. The output control unit 24 of the terminal 10ab unmutes the video output. Thus, the video based on image data of the terminal 10db on the operator side transmitted via the relay apparatus 30 is controlled so that outputting the video starts on the display 120ab.

Further, the output control unit 24 of the terminal 10ab unmutes the mike 114 and the speaker 115 of the terminal itself. By unmuting the speaker 115, outputting sound from the speaker 115 is started, based on sound data of the terminal 10db on the operator side transmitted via the relay apparatus 30. Further, by unmuting the mike 114, sound data of actual sound is transmitted to the terminal 10db on the operator side. Thus, sound is output from the speaker 115 based on the sound data from the terminal 10ab on the customer side at the terminal 10db on the operator side.

As a part of Step S110, the output control unit 24 of the terminal 10db associates the image data of the terminal 10ab on which output of the content is permitted, with a message indicating that the call is being processed, and outputs the message on the display 120db. FIG. 14B is a diagram that illustrates an example of a video-conference screen. As shown in FIG. 14B, the operator can grasp which one of the multiple customers he/she is calling.

Next, if a request for starting a call is received at the other terminal 10aa on the customer side, substantially the same process as Steps S101 to S106 is executed except that the terminal 10ab is replaced with the terminal 10aa. On the terminal 10db on the operator side, Step S106 associates the image data of the terminal 10aa being the source of the start request, with a message for indicating the reception of the start request of the terminal 10aa side, and outputs the message on the display 120db. FIG. 14C is a diagram that illustrates an example of a video-conference screen on the terminal 10db. As shown in FIG. 14C, the operator can confirm a state of the terminal 10aa side waiting for calling while calling with the customer of the terminal 10ab side. Thus, the operator may make a decision to terminate the call with the customer of the terminal 10ab side early.

When terminating the call, depending on operational input by the user, the operation input accepting unit 12 of the terminal 10db receives a request for terminating the call with the customer of the terminal 10ab side (Step S121).

Once the request for terminating the call has been received by the terminal 10db, the sending and receiving unit 21 transmits information about the request for terminating, to request to stop outputting the contents of the terminal 10db on the terminal 10ab, to the management system 50 (Step S122). The information about the request for termination includes the communication ID of the terminal 10db requesting to stop outputting, and the communication ID of the terminal 10ab being the destination of the request.

In response to receiving the information about the request for termination from the terminal 10db on the operator side, the sending and receiving unit 51 of the management system 50 transmits the received information about the request for termination to the terminal 10ab being the destination of the request (Step S123).

Once the information about the request for termination has been transmitted/received between the terminals (10ab, 10db), the output control units 24 of the terminals (10ab, 10db) control stopping output of sound data of the terminal 10 on the partner side (Steps S124 and S125). Further, once the information about the request for termination has been transmitted/received between the terminals (10ab, 10db), the output control unit 24 of the terminal 10ab on the customer side controls stopping output of image data of the terminal 10db on the operator side, whereas the output control unit 24 of the terminal 10db on the operator side does not stop outputting image data of the terminal 10ab on the customer side (Steps S124 and S125).

An example of the output control method will be described specifically. The output control unit 24 of the terminal 10ab mutes the video output. Thus, outputting image data of the terminal 10db on the operator side transmitted via the relay apparatus 30 on the display 120ab is stopped.

Further, the output control unit 24 of the terminal 10ab mutes the mike 114 and the speaker 115 of the terminal itself. By muting the speaker 115, outputting sound data of the operator side transmitted via the relay apparatus 30 from the speaker 115 is stopped. Further, by unmuting the mike 114, sound data of silent sound is transmitted to the terminal 10db on the operator side. Thus, outputting sound data of the terminal 10ab from the speaker 115 is stopped at the terminal 10db on the operator side.

When the above process has completed, the terminal 10db may receive permission to output the content data of the terminal itself at a terminal 10 on the customer side, for example, the terminal 10aa or the like. This process is similar to Step S107 described above, and the description is omitted.

### Modified Example of Embodiment

Next, a modified example of the embodiment will be described in terms of different points from the embodiment. In the above embodiment, an example has been described in which the terminal 10 controls outputting content data. In the modified example, the management system 50 controls outputting content data at the terminal 10.

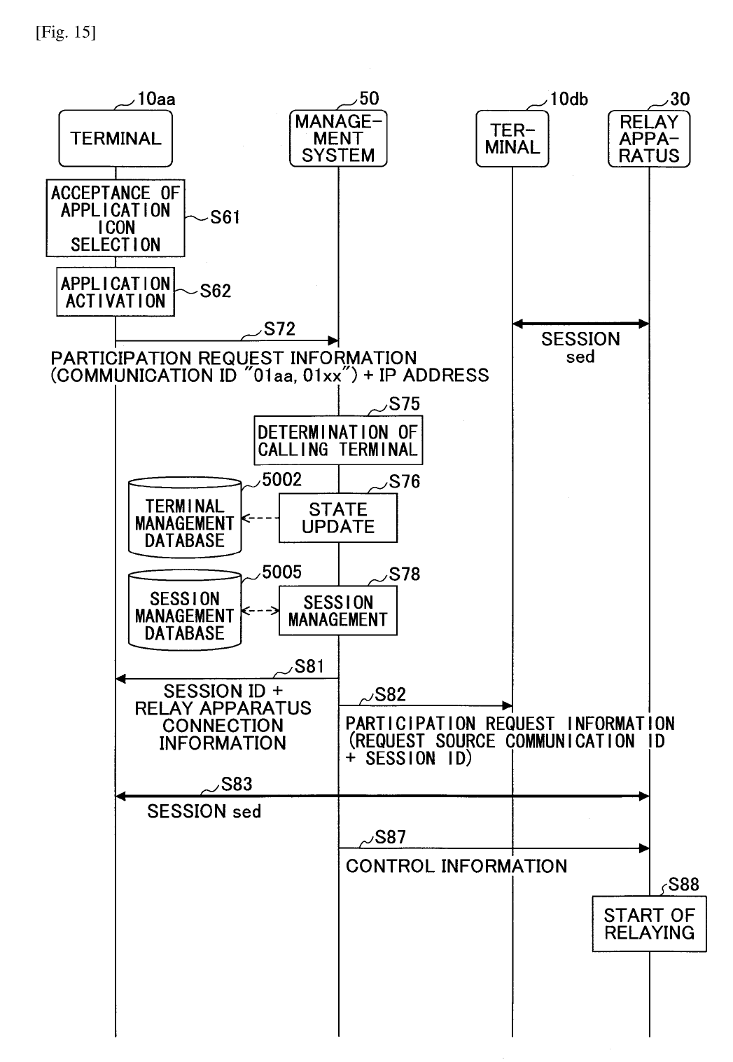

FIG. 15 is a sequence chart that illustrates a process of requesting for participation in a session. Once the communication has been established between the terminals (10aa, 10db), the session control unit 58 of the management system 50 transmits control information for controlling transmission of content data to the relay apparatus 30 via the sending and receiving unit 51 (Step S87). This control information includes the following commands.

The first command is a command to inhibit image data and sound data transmitted by the terminal 10db on the operator side, from being transmitted to the terminal 10aa on the customer side. The second command is a command to inhibit sound data among content data transmitted by the terminal 10aa on the customer side, from being transmitted to the terminal 10db on the operator side. The third command is a command to start transmitting image data among the content data transmitted by the terminal 10aa, to the terminal 10db.

In response to receiving the control information, the relay apparatus 30 follows the above commands, and starts relaying image data among the content data transmitted from the terminal 10aa to the terminal 10db (Step S88). This makes it possible for the terminal 10db to start outputting a video of the customer side, based on the image data of the terminal 10aa transmitted via the relay apparatus 30. On the other hand, the terminal 10db on the operator side cannot start outputting sound of the customer side until sound data of the terminal 10aa is transmitted via the relay apparatus 30. The terminal 10aa on the customer side cannot start outputting video and sound of the operator side until image data and sound data of the terminal 10db are transmitted via the relay apparatus 30.

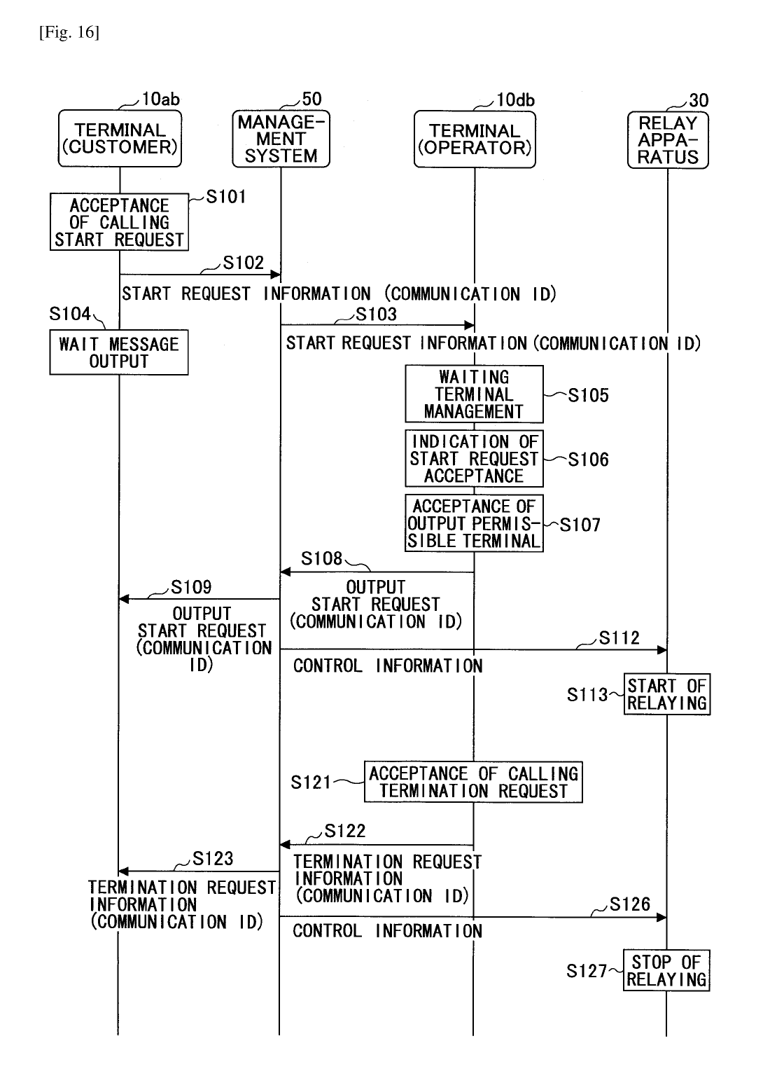

FIG. 16 is a sequence chart that illustrates a process of starting or stopping output of content data. Once a request for starting output has been transmitted/received between the terminals (10ab, 10db), the session control unit 58 of the management system 50 transmits control information to control transmitting content data to the relay apparatus 30 via the sending and receiving unit 51 (Step S112). This control information includes the following commands.

The first command is a command to start transmitting image data and sound data transmitted from the terminal 10db on the operator side to the terminal 10ab. The second command is a command to start transmitting sound data transmitted from the terminal 10ab on the customer side to the terminal 10db.

In response to receiving the control information, the relay apparatus 30 follows the commands, and starts relaying the image data and sound data transmitted from the terminal 10db to the terminal 10ab (Step S113). Further, following the above commands, the relay apparatus 30 starts relaying the sound data transmitted from the terminal 10ab to the terminal 10db (Step S113). On the terminal 10db on the operator side, it becomes possible to start outputting the sound data of the terminal 10ab on the customer side newly transmitted via the relay apparatus 30, in addition to the image data on the customer side that has been already output. On the terminal 10ab on the customer side, it becomes possible to start outputting video and sound because the image data and sound data of the terminal 10db are now transmitted via the relay apparatus 30. Once outputting the video and sound has started on the terminals (10ab, 10db), talking can be started between the operator and the customer.

Once the information about the request for termination has been transmitted/received between the terminals (10ab, 10db), the session control unit 58 of the management system 50 transmits control information to control transmitting content data to the relay apparatus 30 via the sending and receiving unit 51 (Step S126). This control information includes the following commands.

The first command is a command to stop transmitting the image data and sound data transmitted from the terminal 10db on the operator side to the terminal 10ab on the customer side. The second command is a command to stop transmitting the sound data transmitted from the terminal 10ab on the customer side to the terminal 10db on the operator side.

In response to receiving the control information, the relay apparatus 30 follows the above commands, and stops relaying the image data and sound data transmitted from the terminal 10db to the terminal 10ab (Step S127). Further, the relay apparatus 30 follows the above commands, and stops relaying the sound data transmitted from the terminal 10ab to the terminal 10db (Step S127). Since the sound data is not transmitted anymore from the terminal 10ab on the customer side, on the terminal 10db on the operator side, outputting the sound of the customer side is stopped. However, since the image data of the terminal 10ab on the customer side continues to be transmitted to the terminal 10db on the operator side via the relay apparatus 30, outputting the video of the customer side can be continued. On the other hand, since the image data and sound data of the terminal 10db are not transmitted anymore to the terminal 10ab on the customer side, outputting the video and sound of the operator side is stopped. Once outputting the sound of the partner side has been stopped on the terminals (10ab, 10db), the call cannot be performed between the operator and the customer.

### Effect of Embodiment

According to the communication management method in the above embodiment, once communication has been established between one or more terminals 10 on the customer side (an example of a communication terminal on one side) and a terminal 10 on the operator side (an example of a communication terminal on another side), the output control unit 24 of the terminal 10 on the operator side (an example of an output control unit on the other side) executes control for starting output of content data of the terminals 10 of the customer side at the terminal itself. After the control has been executed to start outputting content data of the terminals 10 of the customer side at the terminal 10 on the operator side, the sending and receiving unit 21 (an example of a start request reception unit) of one of terminals 10 on the customer side receives a request for starting output to start outputting content data of the terminal 10 of the operator side at the terminals 10 on the customer side, from the terminal 10 on the operator side (an example of receiving a request for starting output). Based on the request for starting output, the output control unit 24 (an example of an output control unit on the one side) of the terminal 10 on the customer side being the destination of the output request executes control for starting output of content data of the terminal 10 of the operator side. According to the method, the operator can confirm appearance of the customer, based on the content data on the customer side before making a request for starting a call. Thus, the operator can guess content of the call from the appearance of the customer, and hence, usability of the communication system 1 is improved. It should be noted that the terminals 10 in the communication system 1 are examples of an information processing apparatus.

In this case, the output control unit 24 of the terminal 10 can execute control for starting the output by unmuting. Thus, without putting a load on the management system 50, outputting content data can be controlled by a simple process on the terminal 10 side.

In response to receiving a request for starting a call by the customer side, the output control unit 24 of the terminal 10 on the operator side (an example of an indication unit) associates an indication of reception of the request for starting a call with content data of the terminal 10 being the source of the request for starting a call (an example of identification information to identify one side of a start request), and outputs the indication. Thus, if there are multiple terminals on the customer side, it is possible to identify at the operator side which terminal 10 on the customer side makes a request for starting a call.

In this case, the output control unit 24 of the terminal 10 on the operator side may output the elapsed time since the reception of the request for starting a call, by associating it with the content data of the terminal 10 being the source of the request for starting a call. Therefore, if receiving requests for starting a call from multiple terminals 10 on the customer side, the operator can select one of the terminals 10 on the customer side as a call partner that has the longest elapsed time since the reception of the request for starting a call.

In the communication system 1, a request for terminating a call can be transmitted between the terminal 10 on the customer side and the terminal 10 on the operator side. Based on the request for termination, the output control unit 24 of the terminal 10 on the customer side controls stopping output of image data of the terminal 10 on the operator side (an example of content data). The output control unit 24 of the terminal 10 on the operator side does not control stopping output of image data of the terminal 10 on the customer side based on the request for termination. Thus, calling by bidirectional transmission of content data becomes unavailable. On the other hand, if a new customer appears in the image capturing range of the terminal 10 on the customer side, the operator can confirm appearance of the customer before making a request for starting a call.

According to the modified example of the embodiment, when communication has been established between one or more terminals 10 on the customer side and a terminal 10 on the operator side, the session control unit 58 of the management system 50 (an example of an output control unit on another side) transmits control information to the relay apparatus 30, to execute control for starting output of content data of the terminal 10 of the customer side at the terminal 10 on the operator side. After the control has been executed for starting output of content data of the terminal 10 of the customer side at the terminal 10 on the operator side, the sending and receiving unit 51 of the management system 50 (an example of a start request reception unit) receives a request for starting output by the terminal 10 on the operator side to start outputting content data of the terminal 10 of the operator side at one of the terminals 10 on the customer side. Based on the request for starting output, the session control unit 58 of the management system 50 (an example of an output control unit on the other side) transmits control information to the relay apparatus 30, to execute control for starting output of content data of the terminal 10 of the operator side at the terminal 10 on the customer side being the destination of the request for starting output. Thus, outputting content data at the terminal 10 can be controlled on the management system 50 side.

<<Supplementary Description of Embodiments>>

It should be noted that the management system 50 and the program providing system 90 in the above embodiments may be constituted with a single computer, or constituted with multiple computers to which corresponding units (functions or means) are arbitrarily partitioned and assigned. Further, if the program providing system 90 is constituted with a single computer, a program transmitted by the program providing system 90 may be transmitted by partitioning the program into multiple modules, or may be transmitted without partitioning. Furthermore, if the program providing system 90 is constituted with multiple computers, a program may be transmitted from the computers in a state where the program is partitioned into multiple modules.

Further, a recording medium in which a terminal program, a relay apparatus program, and a communication management program of the communication system 1 are stored, an HD 204 in which the above programs are stored, and the program providing system 90 including the HD 204 can be provided as program products for domestic or overseas users of the terminal program, the relay apparatus program, and the communication management program.

Furthermore, although in the communication system 1, the IP address of a terminal is managed in the terminal management table shown in FIG. 7B, it is not limited to that, but respective FQDNs (Fully Qualified Domain Names) may be managed as long as they are terminal identification information to identify the respective terminals 10 on the communication network 2. In this case, the IP address corresponding to a FQDN is obtained by a known DNS (Domain Name System) server.

In the communication system 1, the “video conference” is used as a term which can be replaced by “TV conference”.

Further, in the above communication system 1, as an example of the communication system 1, a case of a video conference system has been described, but it is not limited to that, but may be a car navigation system. In this case, for example, one terminal 10 corresponds to a car navigation device installed in an automobile, and another terminal 10 corresponds to a management terminal or a management server in a management center that manages car navigation, or a car navigation device that is installed on another automobile.

Furthermore, the communication system 1 may be an audio conference system or a personal computer (PC) screen sharing system. Further, the communication system 1 may be a communication system for Internet protocol (IP) telephones, Internet telephones, or mobile telephones. In the above cases, for example, the terminal 10 corresponds to a telephone such as a mobile telephone terminal.

Further, content data may be sound data generated in a body such as pulse sound or heartbeats, image data that represents a waveform of an electrocardiogram or change of the body temperature, or coordinates data that represents information in the body. Thus, the communication system 1 of the embodiment can be used as a remote medical system.

Further, although image data and sound data have been described as examples of content data in the above embodiment, it is not limited to that, but may be tactile sensation (touch) data. In this case, sensation of touch by a user on one terminal side is transferred to the other terminal side. Furthermore, content data may be olfactory sensation (smell) data. In this case, sensation of smell on one terminal side is transferred to the other terminal side. Further, content data may be streaming data (medium) at least one of data items among image data, sound data, tactile sensation data, and olfactory sensation data.

It should be noted that the terminals 10 may be used not only for a call between multiple offices, and a call between different rooms in the same office, but also for a call in the same room, and a call between the outdoors and indoors or between the outdoors and outdoors. If the terminals 10 are used outdoors, wireless communication may be executed through a cellular phone communication network or the like. Further, although a case of a video-conference by the communication system 1 has been described in the above embodiment, but it is not limited to that; the communication system may be used for a meeting, ordinary conversation between family members of friends, or presentation of information in one direction.

Further, the present invention is not limited to these embodiments and examples described above, but various variations and modifications may be made without departing from the scope of the present invention.

The present application is based on and claims the benefit of priority of Japanese Priority Application No. 2015-145711 filed on Jul. 23, 2015, with the Japanese Patent Office, the entire contents of which are hereby incorporated by reference.

### CITATION LIST

### Patent Literature

### PTL 1: Japanese Laid-open Patent Publication No. 2012-191598

### PTL 2: Japanese Laid-open Patent Publication No. 2005-064860

### REFERENCE SIGNS LIST

10 terminal
11 sending and receiving unit
12 operation input accepting unit
13 display control unit
19 storing and reading unit
21 sending and receiving unit
22 activation unit
24 output control unit
25 function execution unit
29 storing and reading unit
30 relay apparatus
50 management system
51 sending and receiving unit
52 authentication unit
53 management unit
58 session control unit
59 storing and reading unit
5000 memory unit
5001 authentication management DB
5002 terminal management DB
5003 application use permission management DB
5005 session management DB
5010 group information management DB

1. A communication system, comprising:
an output control unit on another side configured, when communication has been established between one or more communication terminals on one side, and a communication terminal on the other side, to execute control for starting output of content data of the communication terminals on the one side at the communication terminal on the other side;
a start request reception unit configured, when the control has been executed for starting the output of the content data of the communication terminals on the one side at the communication terminal on the other side, to receive a request for starting the output of the content data of the communication terminal on the other side at one of the communication terminals on the one side, by the communication terminal on the other side; and
an output control unit on the one side configured to execute, based on the request for the starting, the control for starting the output of the content data of the communication terminal on the other side at the one of the communication terminals on the one side.

2. A communication system, comprising:
a communication terminal on another side that includes
an output control unit on the other side configured, when communication has been established with one or more communication terminals on one side, to execute control for starting output of content data of the communication terminals on the one side; and
a communication terminal on the one side that includes
a start request reception unit configured, when the control has been executed for starting the output of the content data of the communication terminals on the one side at the communication terminal on the other side, to receive a request for starting the output of the content data of the communication terminal on the other side at the one of the communication terminals on the one side, by the communication terminal on the other side, and
an output control unit on the one side configured to execute, based on the request for the starting, the control for starting the output of the content data of the communication terminal on the other side.

3. The communication system as claimed in claim 2, wherein the output control unit is further configured to execute the control for starting the output by unmuting.

4. A communication system, comprising:
a communication management system that includes
an output control unit on another side configured, when communication has been established between one or more communication terminals on one side, and a communication terminal on the other side, to execute control for starting output of content data of the communication terminals on the one side at the communication terminal on the other side,
a start request reception unit configured, when the control has been executed for starting the output of the content data of the communication terminals on the one side at the communication terminal on the other side, to receive a request for starting the output of the content data of the communication terminal on the other side at one of the communication terminals on the one side, by the communication terminal on the other side, and
an output control unit on the one side configured to execute, based on the request for the starting, the control for starting the output of the content data of the communication terminal on the other side at the one of the communication terminals on the one side;
the communication terminal on the one side; and
the communication terminal on the other side.

5. The communication system as claimed in claim 4, wherein the output control unit on the other side is further configured to execute the control, by a command to start transmitting the content data on the one side to the communication terminal on the other side,
wherein the output control unit on the one side is further configured to execute the control, by a command to start transmitting the content data on the other side to the communication terminal on the one side.

6. The communication system as claimed in claim 1, wherein the communication terminal on the other side further includes an indication unit configured, in response to receiving the request for starting a call by the one side, to associate an indication of receiving the request for starting a call with identification information for identifying the one side being a source of the request for starting a call, and to output the indication.

7. The communication system as claimed in claim 6, wherein the indication unit is further configured to execute control for outputting an elapsed time since the request for starting a call has been received, having the identification information associated.

8. The communication system as claimed in claim 1, wherein a request for terminating a call can be transmitted between the communication terminal on the one side and the communication terminal on the other side,
wherein the output control unit on the one side executes control for stopping the output of the content data of the communication terminal on the other side, based on the request for termination,
wherein the output control unit on the other side does not execute control for stopping the output of the content data of the communication terminal on the one side, based on the request for termination.

9. A communication management method executed by an information processing apparatus, the method comprising:
executing at another side, when communication has been established between one or more communication terminals on one side, and a communication terminal on the other side, control for starting output of content data of the communication terminals on the one side at the communication terminal on the other side;
receiving, when the control has been executed for starting the output of the content data of the communication terminals on the one side at the communication terminal on the other side, a request for starting output of content data of the communication terminal on the other side at one of the communication terminals on the one side, by the communication terminal on the other side; and
executing at the one side, based on the request for the starting, the control for starting the output of the content data of the communication terminal on the other side at the one of the communication terminals on the one side.

10. A non-transitory computer-readable recording medium having a program stored therein for causing an information processing apparatus to execute a process, the process comprising:
executing at another side, when communication has been established between one or more communication terminals on one side, and a communication terminal on the other side, control for starting output of content data of the communication terminals on the one side at the communication terminal on the other side;
receiving, when the control has been executed for starting the output of the content data of the communication terminals on the one side at the communication terminal on the other side, a request for starting output of content data of the communication terminal on the other side at one of the communication terminals on the one side, by the communication terminal on the other side; and
executing at the one side, based on the request for the starting, the control for starting the output of the content data of the communication terminal on the other side at the one of the communication terminals on the one side.
